(19) United States
(12) Patent Application Publication
(10) Pub. No.: US 2024/0296739 A1
(43) Pub. Date: Sep. 5, 2024

(54) PARKING SPOT FINDER HAVING VISUAL ENHANCEMENT TO REDUCE STRESS

(71) Applicant: TOYOTA MOTOR NORTH AMERICA, INC., Plano, TX (US)

(72) Inventors: Ryuichi Danno, AICHI (JP); Oral Kaplan, Tokyo (JP); Minami Hori, Stockbridge, MI (US); Yoshiya Matsuhisa, Gifu (JP); Go Yamazaki, Tokyo (JP); Kazuma Masuda, Aichi (JP)

(73) Assignees: TOYOTA MOTOR NORTH AMERICA, INC., Plano, TX (US); TOYOTA JIDOSHA KABUSHIKI KAISHA, Aichi-Ken (JP)

(21) Appl. No.: 18/178,066

(22) Filed: Mar. 3, 2023

(51) Int. Cl. G08G 1/14; G01C 21/34; G01C 21/36; G06Q 30/0226

(52) U.S. Cl. CPC G08G 1/145; G01C 21/3476; G01C 21/362; G01C 21/3647; G06Q 30/0226; G08G 1/143

(57) ABSTRACT

Method and systems for selecting available parking spots based on a skill level of the driver and a grade of the available parking spots. Map data is received by a vehicle via a network upon entering a parking area. Available parking spots are determined based on the map data. The parking spots are graded by a parking spot identifier based in at least the difficulty to park in the parking spot. The skill level of the driver is also graded by the parking spot identifier. At least one parking spot is selected by the parking spot identifier from the available parking spots based on the skill level of the driver and the grade of the available parking spots. A determination is made if the at least one selected parking spot includes a financial incentive to park in the selected parking spot.

### FIELD

The present disclosure generally relates to a parking spot finder and guidance system, and, more particularly, a visually enhanced parking spot finder and guidance system.

### BACKGROUND

Conventional parking spot finder systems, which includes Electric Vehicle (EV) charging station finder applications, enable drivers to locate parking lots and multi-story parking garages based on their desired location and/or a desired need (e.g., EV charging station). However, these conventional systems bring a driver to the entrance of the parking lot or garage, rather than to an individual parking spot. Once the driver enters the parking lot or the garage, the driver spends significant amount of time, energy, and fuel trying to find a suitable parking spot. During this time, the vehicle of the user is generating a significant amount of emission.

Accordingly, a parking spot finder system is needed that provides last mile parking guidance for cost and stress reduction, as well as sustainable development through optimized resource consumption.

### SUMMARY

In one example embodiment, a computer-implemented method includes: receiving map data, by a parking spot identifier, via a network, upon entering a parking area; wherein the map data comprises sensor data, and wherein the parking spot identifier comprises a controller; determining, by the controller, available parking spots of the parking area based on the map data; grading, using the controller, one or more available parking spots of the parking area; grading, using the controller, a skill level of a driver; selecting, by the controller, a parking spot from the available parking spots, wherein the selection is based on the skill level of the driver and the grade of the one or more available parking spots; and wherein the selection includes determining if the selected parking spot includes a financial incentive if the driver parks in the respective selected parking spot; and outputting the selection on a display.

In another example embodiment, a system includes a parking database, a parking database, wherein the parking database includes map data, and wherein the parking database is in communication with a parking spot identifier; a parking spot identifier, wherein the parking spot identifier includes a controller, wherein the controller is configured to: receive, via a network, the map data upon entering a parking area; determine available parking spots of the parking area based on the map data; grade one or more available parking spots of the parking area based on at least difficulty to park in the corresponding available parking spot; grade a skill level of a driver; select one parking spot from the available parking spots, wherein the selection is based on the skill level of the driver and the grade of the one or more available parking spots; and determine if the one selected parking spot comprises a financial incentive if the driver parks in the selected parking spot; and a display, wherein the display is configured to output the one selected parking spot.

In one example embodiment, a system includes a parking database, wherein the parking database includes map data, wherein the map data includes sensor data from a parking area, wherein the parking database is in communication with a parking spot identifier, and wherein the parking spot identifier includes a controller; the controller configured to: receive, via a network, the map data upon entering the parking area; determine available parking spots of the parking area based on the received map data; grade the one or more available parking spots of the parking area based on at least difficulty to park in the corresponding available parking spot; grade a skill level of a driver; select one parking spot from the available parking spots to display to the driver of the vehicle, wherein the selection is based on the skill level of the driver and the grade of the one or more available parking spots; determine that the selected parking spot includes an incentive if the driver parks in the selected parking spot; and determine that the driver has parked in the selected parking spot; and a display, wherein the display is configured to output at least the selected parking spot.

It is to be understood that both the foregoing general description and the following detailed description are exemplary and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In addition, the present disclosure may repeat reference numerals, letters, or both in the various examples. This repetition is for the purpose of simplicity and clarity and does not in itself dictate a relationship between the various embodiments and/or configurations discussed.

FIG. 1 is a block diagram depicting a vehicle in accordance with one or more embodiments.

FIG. 2A is a flowchart of a method for selecting and displaying a parking spot for a driver in accordance with one or more embodiments.

FIG. 2B is a flowchart of a method for incentivizing the driver for parking in the selected parking spot of FIG. 5 in accordance with one or more embodiments

FIG. 3 is a diagrammatic illustration of a visually enhanced 2-D map of a parking lot in accordance with one or more embodiments.

FIG. 4 is another diagrammatic illustration of another visually enhanced 2-D map of a parking lot in accordance with one or more embodiments.

FIG. 5 is yet another diagrammatic illustration of a visually enhanced 3-D map of a parking lot in accordance with one or more embodiments.

### DETAILED DESCRIPTION

Illustrative embodiments and related methods of the present disclosure are described below as they might be employed in one or more methods and systems for determining a parking spot for a driver based on the skill of the driver and the graded difficulty of the parking spot. In the interest of clarity, not all features of an actual implementation or method are described in this specification. It will of course be appreciated that in the development of any such actual embodiment, numerous implementation specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure. Further aspects and advantages of the various embodiments and related methods of the disclosure will become apparent from consideration of the following description and drawings.

The example embodiments described below recognize that it may be desirable to have methods and systems that more efficiently manage parking in a parking area such as a parking lot or garage, which will in turn reduce emissions of the vehicle and reduce parking times and stress for the driver. In particular, the embodiments described below provide methods and systems for taking into account the skill of the driver and the difficulties of the parking spot in determining whether to select a particular parking spot for a particular driver. Therefore, the methods and systems provide an improvement to the technical field of parking guidance systems and methods.

One or more embodiments described below provide methods and systems for determining the skill and preferences of the driver as well as the characteristics of the parking spot (e.g., difficulty to park, EV charging station, location to an entrance, etc.) to select an appropriate parking spot for the driver. These methods and systems execute selecting a parking spot for the driver, displaying a visually enhanced route to the selected parking spot, and providing an incentive system for parking in the selected parking spot. In particular, an incentive may be used to encourage the driver to park in a difficult parking spot. Therefore, the methods and systems provide an improvement to parking selection systems and methods.

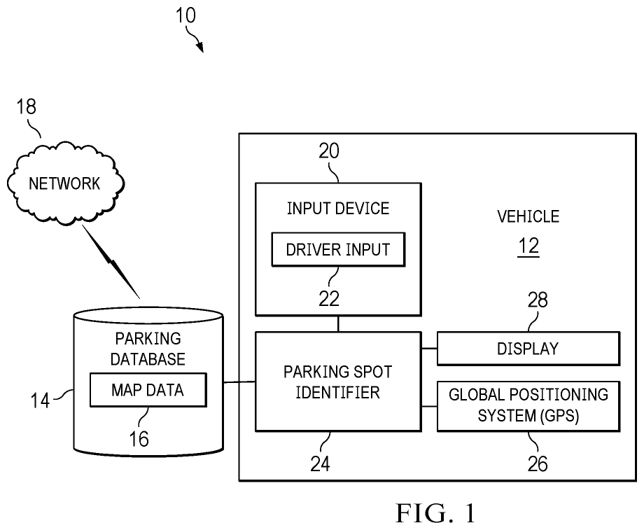

Referring to FIG. 1, in an embodiment, a parking spot finder system is generally referred to by reference numeral 10. The parking spot finder system 10 comprises a vehicle 12. The vehicle 12 is in communication with a parking database 14, which includes map data 16. The map data 16 may be sent to the vehicle 12 over a network 18. The vehicle 12 also includes an input device 20, driver input 22, a parking spot identifier 24, a global positioning system (GPS) 26, and a display 28. The input device 20 is in communication with and/or operably coupled to a parking spot identifier 24. A GPS 26 is in communication with and/or operably coupled to the parking spot identifier 24. A display 28 is in communication with and/or operably coupled to the parking spot identifier 24.

In one example embodiment, vehicle 12 is an automotive vehicle. In one or more embodiments, the vehicle 12 is an electric vehicle (EV). In other embodiments, the vehicle 12 is a hybrid vehicle. In other embodiments, the vehicle 12 has an internal combustion engine.

In one or more embodiments, the parking database 14 is stored on the vehicle 12 and receives updates via the network 18. In one or more embodiments, the parking database 14 also stores the driver input 22 such as desired parking settings. In some embodiments, the parking database 14 is stored on a central server remote from the vehicle 12. In one or more embodiments, the parking database 14 is shared with the GPS 26 and/or a navigation system.

In some embodiments, the map data 16 is 2-dimensional map data. In other embodiments, the map data 16 is 3-dimensional map data. In some embodiments, the map data 16 includes a plurality of sensor data. In one or more embodiments, the sensor data includes data from sensors in the parking area such as infrared sensors, individual sensors in each parking spot, or camera data. In some embodiments, the sensor data includes data from sensors on the vehicle 12. In some embodiments, the sensor data includes audio and/or visual data from one or more cameras. In some embodiments, the map data 16 is stored in the parking database 14. In other embodiments, the map data 16 is stored on recorded medium such as disk, CD-ROM, DVD, or other storage device. In some embodiments, the map data 16 is stored on a central server and transmitted over the network 18 to the vehicle 12. The map data 16 may, in some embodiments, include one or more of: parking area information, vehicle information, layout of a parking area, levels of parking structure, size of each parking space, location of each parking space, required method to park in each parking space, available parking spaces, parking spaces with special features related to skill need to park in parking space, parking spaces with an EV charger, parking spaces with a fuel station, accessible parking spaces, maternity parking spaces, high or low mobility required parking spaces, and the like. In some embodiments, the map data 16 is for a parking lot. In other embodiments, the map data 16 is for a parking garage. In yet other embodiments, the map data 16 includes a plurality of parking lots and/or garages. In some embodiments, the map data 16 includes the required method to park in each parking space, which may include parallel parking or may require backing into a parking spot. In some embodiments, the map data 16 is updated in real-time. In some embodiments, the map data 16 is transmitted and/or updated upon entering a parking structure, which may include a parking lot or parking garage. In one or more embodiments, the map data 16 is sent when the vehicle 12 passes a geo-fence or other device that sends a signal triggering that the vehicle 12 needs guidance to a parking spot in the parking area. In some embodiments, the map data 16 includes a visual depiction of the parking area, structure of the parking area, and/or vehicles in the parking area. In some embodiments, each parking space in the parking area has a sensor or controller to determine if a vehicle is parked in the spot and this information is a portion of the map data 16. In one or more embodiments, the visual depiction is based on camera data taken from the parking area. In other embodiments, the visual depiction is based on sensors such as infrared sensors and the like. In some embodiments, the map data 16 includes a visually enhanced 2-D image or map. In one or more embodiments, the map data 16 includes a visually enhanced 3-D image, video, or map.

In some embodiments, the network 18 may include a 3G network, a 4G Network, a 5G network, Wi-Fi network, or the like. In one or more embodiments, the network 18 is in communication with a central server (e.g., a cloud server). In one or more embodiments, the central server may provide information and services including but not limited to include location, mapping, route or path, and topography information, which may form all or a portion of the parking database 14. In one or more embodiments, external communication (including but not limited to software updates, firmware updates, data transmission between a processor of the vehicle 12 and central server) may be accomplished using any suitable wireless or wired communication technology, e.g., a cable interface such as a USB, micro-USB, Lightning, Bluetooth, or the network 18. In some embodiments, the parking database and the driver input is stored on a central server and transmitted to the vehicle 12 over wired or wireless means (e.g., network 18).

In some embodiments, the input device 20 is a component of the vehicle 12. In one or more embodiments, the input device 20 is the display 28 or a portion of the display 28. In some embodiments, the input device 20 is located within a console of the vehicle near a driver seat of the vehicle. In other embodiments, the input device 20 may be a remote device and/or a local device such as a laptop, tablet, or handheld device. In some embodiments, the input device 20 is a remote device that may transmit the driver input 22 over the network 18 or the like to the parking spot identifier 24.

In some embodiments, the driver input 22 includes any one or more of: parking preferences and driving history. In some embodiments, parking preferences include one or more of: parking spot preferences such as needing an energy transfer system (e.g., EV charging), needing a parking spot close to an entrance, needing a parking spot with a low skill rating for parking, the driver's self-assigned skill level for parking, and the like. In some embodiments, driving history includes one or more of: type of vehicle the driver has been driving, length of time the driver has been driving, driver demographics, the length of time that the driver has been driving this particular vehicle, the success rate of the driver attempting to park, the parking spot identifier 24's determined parking skill level of the driver, and the like. The driver input 22 may be input on the input device 20 via a touch screen, buttons, keyboard, audio input, and the like. In some embodiment, the driver input 22 may be stored in the parking database 14 for future use by the vehicle 12. In other embodiments, the driver input 22 may be stored in a separate database for future use by the vehicle 12. In some embodiments, the driver input 22 is set by the driver prior to or upon entering a parking area and is sent to the parking spot identifier 24 of vehicle 12 for processing. In other embodiments, the driver input 22 is set in advance to finding a parking spot and is a stored as set preference and is sent to the parking spot identifier 24 of vehicle 12 for processing. In some embodiments, the driver input 22 is a combination of new input for a parking spot and stored historical driver input that is sent to the parking spot identifier 24 of the vehicle 12 for processing.

In some embodiments, the parking spot identifier 24 is one or more controllers or a microcomputer. In one or more embodiments, the parking spot identifier 24 is one or more vehicle electronic control units (ECUs). In some embodiments, the parking spot identifier 24 may include one or more processors or controllers, which may be specifically designed for automotive systems. In one or more embodiments, the parking spot identifier 24 may receive map data 16 and driver input 22 from input device 20 and make parking determinations based on the received data and input. In some embodiments, the parking spot identifier 24 may also include memory, which may include any non-transitory memory known in the art. In some embodiments, the memory may store machine-readable instructions usable by the parking spot identifier 24 and may store other data requested by the parking spot identifier.

In some embodiments, the GPS 26 is in communication with the parking spot identifier 24 and sends real-time location data to the parking spot identifier 24.

In one or more embodiments, the display 28 is a display inside the vehicle 12 that outputs a 2-D map or 2-D guidance. In other embodiments, the display 28 is a display inside the vehicle 12 that outputs a 3-D map. In some embodiments, a 3-D mapping software is used to generate the 3-D map. In some embodiments, the display is an augmented reality (AR) display that shows available parking spots in a parking space. In one or more embodiments, the display 28 shows the parking lot and/or a parking garage and a path or route to a particular parking spot. In some embodiments, the display 28 will show other vehicles parked in the parking area. In one or more embodiments, the display 28 displays vehicle 12 at least in part on the display 28. In some embodiments, the display 28 depicts parking spots of different parking difficulty levels in different colors or with a different graphical indicator. In some embodiments, the display 28 depicts parking spots with different features (e.g., electric vehicle charging) in different colors or with a different graphical indicator. In some embodiments, the display 28 shows a box in a graphical user interface of the display. The box allows the driver to select the suggested parking spot or to pick an alternative parking spot. In some embodiments, the display 28 is placed in a central panel or behind the steering wheel of the driver. In one or more embodiments, the display 28 includes a graphical user interface with a plurality of panels showing multiple views of the parking area and/or route to a selected parking spot. In some embodiments, the display 28 is a graphical user interface with a touchscreen, keyboard, or other input device such as input device 20 that allows the driver to make a selection on the display. In some embodiments, the display 28 depicts one or more open parking spots and includes a graphical representation depicting a grade (e.g., easy, medium, or difficult) of the one or more open parking spots. In one or more embodiments, the grades of the one or more open parking spots are depicted by a certain color. For example, green for a parking spot that was graded easy, yellow/orange for an medium level parking spot, and red for a difficult level parking spot. In other embodiments, a graphical indicator and/or a text notation is used to mark the grade/required skill of the one or more open parking spots.

In operation, with continuing reference to FIG. 1, a driver of vehicle 12 enters a parking area. When the driver passes a geo-fence, the map data 16 will update based on current conditions of the parking lot, including which parking spots are available and where these parking spots are. The parking database 14 will transmit the updated map data 16 to the parking spot identifier 24. The driver may also select using the input device 20, driver input 22 selecting a criterion required for her parking. The driver input 22 will be sent to the parking spot identifier 24. Additionally, the GPS 26 may transmit information relating to navigation of the vehicle 12 to one or more parking spots in the parking area. The parking spot identifier 24 uses the driver input 22 and the map data 16 to determine a parking spot for the driver. The parking spot identifier uses the GPS 26 and/or the map data 16 to calculate a route to the determined parking spot. The parking spot identifier 24 will send the determined parking spot to the display 28. The display 28 will update, and the driver of vehicle 12 may determine if the driver wants to select this parking spot. The driver of vehicle 12 may proceed to the determined parking spot or select a second, different parking spot.

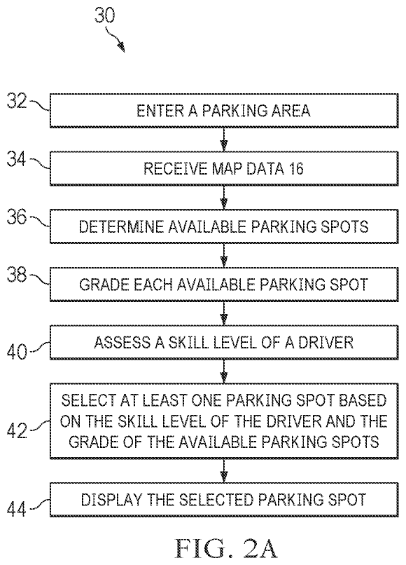

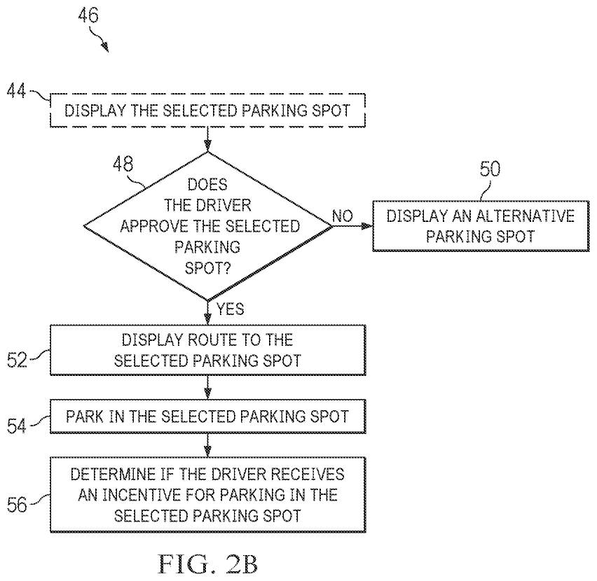

With reference to FIG. 2A and continuing reference to FIG. 1, a method for determining a parking spot for a driver based on a skill level of the driver, according to one or more embodiments. Method 30 is illustrated as a set of operations or blocks 32 through 44 and is described with continuing reference to FIG. 1. Not all of the illustrated blocks 32 through 44 may be performed in all embodiments of method 30. One or more blocks that are not expressly illustrated in FIG. 2A may be included before, after, in between, or as part of the blocks 32 through 44. In some embodiments, one or more of the blocks 32 through 44 may be implemented, at least in part, by the parking spot identifier 24, in the form of executable code stored on non-transitory, tangible, machine-readable media that when run by one or more processors may cause the one or more processors to perform one or more of the processes. In one or more embodiments, the blocks in method 30 are performed within a vehicle, such as vehicle 12 in FIG. 1, by a parking spot identifier 24, which may be an ECU or controller, in FIG. 1.

In an example embodiment, the method 30 includes: entering a parking area at a block 32; receiving map data 16 at a block 34; determining available parking spots at a block 36; grading each available parking spot at a block 38; assessing a skill level of a driver at a block 40; selecting at least one parking spot based on the skill level of the driver and the grade of the available parking spots at a block 43; and display the selected parking spot at a block 44.

In some embodiments, entering the parking area at the block 32 includes passing a geo-fence. In some embodiments, entering the parking area at the block 32 includes passing a sensor. In some embodiments, entering the parking area at the block 32 includes automatically receiving map data 16 at the block 34. In one or more embodiments, the parking area is a parking garage, lot, surface lot, complex, terminal, or a parking area associated with a particular company.

In some embodiments, receiving map data 16 at the block 34 occurs when the vehicle 12 passes a geo-fence, sensor, or the like. In one or more embodiments, the map data 16 is received by the parking spot identifier 24. In some embodiments, the map data 16 is also updated at the block 34. In one or more embodiments, the map data 16 is sent to the parking spot identifier 24 over the network 18.

In some embodiments, the block 32 occurs simultaneously or contemporaneously to the block 34.

In some embodiments, the parking spot identifier 24 determines the available parking spots at the block 36. In some embodiments, the parking spot identifier 24 determines that there are no available parking spots at the block 36 and notifies the driver to proceed to another parking area. In one or more embodiments, the parking spot identifier 24 determines the available parking spots at the block 36 using the received map data 16 from the block 34. In some embodiments, the method further includes receiving driver input 22 from the driver such as a preference for a parking spot with an EV charging station or a preference to park in a difficult parking spot in order to receive an incentive. In one or more embodiments, the parking spot identifier 24 determines the available parking spots at the block 36 using the driver input 22 and/or the map data 16. In one or more embodiments, the driver input 22 and/or the map data 16 is stored in the parking spot identifier 24 or a database in communication with the parking spot identifier 24, such as the parking database 14.

In one or more embodiments, the parking spot identifier 24 grades each of the available parking spots at the block 38 based on the skill required to park in the parking spot. In some embodiments, the skill required to park in the parking spot is based on one or more of: the type of parking needed (e.g., parallel parking or reverse into the parking spot), if the parking spot is narrow, if the parking spot is better suited for compact vehicles, the desirability of the parking spot, and the like. In some embodiments, the desirability of the parking spot includes one or more of: location to the entrance, location to stairs, elevator, or escalator, has a particular feature such as EV charging station, accessibility level, which floor the parking spot is on, required mobility for the spot, whether there is an incentive (such as a financial incentive) to park in a particular parking spot, and the like.

In one or more embodiments, the parking spot identifier 24 includes assessing the skill level of the driver at the block 40. In some embodiments, the driver determines the skill level of the driver using the input device 20 by selecting the skill level using the driver input 22. The driver input 22 may include the driver selecting his/her perceived level of skill related to parking, which is transmitted to the parking spot identifier 24 and/or stored in a memory or database that the parking spot identifier 24 may access. In one or more embodiments, the driver may input that his skill level is novice, intermediate, or expert. In some embodiments, the driver may input his skill level is novice for larger vehicles such as SUVs and trucks but indicate a higher skill level such as intermediate or expert for compact vehicles. In some embodiments, the driver may input his driving history such as how long the driver has been driving vehicle 12, how long the driver has been driving in general, and the like. In some embodiments, the driver may indicate another preference such as requiring EV charging or indicate that the driver has low mobility or an accessibility need that requires the driver to be parked near an entrance. In some embodiments, the parking spot identifier 24 assesses the skill level of the driver at the block 40 using an algorithm based on the driver input 22. In other embodiments, the parking spot identifier 24 determines the skill level of the driver without considering the driver input 22. In some embodiments, the history of the driver's parking and the success of those parking attempts are used to determine skill level of the driver by the parking spot identifier 24. In some embodiments, the parking spot identifier 24 uses both the driver input 22 and the history of the parking of the driver to assess the skill level of the driver at the block 40.

In some embodiments, the block 40 occurs simultaneously or contemporaneously to the block 38. In other embodiments, the block 38 occurs but not the block 40. In some embodiments, the block 40 occurs prior to the block 38.

In some embodiments, the parking spot identifier 24 selects at least one parking spot based on the skill level of the driver and the grade of the available parking spots at the block 42. In some embodiments, the parking spot identifier 24 selects a plurality of parking spots that match both the skill level of the driver and required grade of the parking spots and allows the driver to select from the plurality of parking spots. In one or more embodiments, the assessed skill level of the driver is compared to the grade of the parking spots. In some embodiments, the assessed skill level (e.g., novice) needs to match or exceed the parking spot grade (e.g., easy to park). In some embodiments, different factors related to the skill level of the driver are weighted greater than other factors related to the skill level. For example, accessibility needs of the driver may weight greater than a parking spot with an energy transfer system (e.g., EV charger or fuel station), if that parking spot was not also accessible. In one or more embodiments, the driver may select using the driver input 22 which factors are weighted greater than other factors, relating to the skill level and/or desirability of a parking spot. In some embodiments, the parking spot identifier 24 only finds one match and automatically displays the route to the selected parking spot without asking for the driver of vehicle 12 to approve the selected parking spot.

In some embodiments, the parking spot identifier 24 sends to the display 28 the selected parking spot at the block 44. In some embodiments, the driver may choose to select the selected parking spot or ask for an alternative parking spot, using the display 28 and/or input device 20. In one or more embodiments, the parking spot identifier 24 uses the GPS 26 to calculate a path to the selected parking spot. In some embodiments, the path is sent to the display 28. In some embodiments, the display 28 includes a 2-D map of the parking area. In other embodiments, the display 28 includes a 3-D map of the parking area. In some embodiments, a grouping of a plurality of selected parking spots are displayed at the block 44, and the driver selects from the grouping. In some embodiments, if the driver selects a parking spot that is outside the grouping and graded above the driver's skill level, the display 28 may indicate a warning. In other embodiments, if the driver parks in a parking spot rated difficult to park and parks successfully, the driver's skill level is updated by the parking spot identifier 24. In some embodiments, the display 28 allows the user to select from a grouping of selected parking spots which level of difficulty that the driver of vehicle 12 wants to park at. In some embodiments, the display 28 includes a graphical indicator or information for the grouping of selected information. In one or more embodiments, the graphical indicator or information may include at least one or more of: which level the parking spot is on, if the parking spot includes EV charging, if the parking spot includes a fuel station, if the parking spot is an easy, medium, or difficult parking spot, if the parking spot includes an incentive to park there, and the like.

In some embodiments, after the block 44, the driver may select using either the input device 20 and/or the display 28 the selected parking spot to reserve the parking spot. In some embodiments, this reservation is sent via network 18 to the parking database 14 to update the parking database that this parking spot is no longer available. In some embodiments, the driver may reserve the parking spot in advance to arriving at the entrance, such as the day before.

Referring to FIG. 2B, with continuing reference to FIGS. 1 and 2A, a method for determining if the driver receives an incentive for parking in the selected parking spot, according to one or more embodiments. Method 46 is illustrated as a set of operations or blocks 48 through 56 and is described with continuing reference to FIGS. 1 and 2A. Not all of the illustrated blocks 48 through 56 may be performed in all embodiments of method 46. One or more blocks that are not expressly illustrated in FIG. 2B may be included before, after, in between, or as part of the blocks 48 through 56. In some embodiments, one or more of the blocks 48 through 56 may be implemented, at least in part, by the parking spot identifier 24, in the form of executable code stored on non-transitory, tangible, machine-readable media that when run by one or more processors may cause the one or more processors to perform one or more of the processes. In one or more embodiments, the blocks in method 46 are performed within a vehicle, such as vehicle 12 in FIG. 1, by a parking spot identifier 24, which may be an ECU or controller, in FIG. 1.

In an example embodiment, the method 46 includes: determining if the driver approves the selected parking spot at a block 48; if no, then the method 46 proceeds to a block 50, to display an alternative parking spot; if yes, then the method 46 proceeds to a block 52, to display the route to the selected parking spot; then to a block 54, when the driver parks in the selected parking spot; and then to a block 56, to determine if the driver receives an incentive for parking in the selected parking spot.

In some embodiments, the method 46 occurs after the method 30. In some embodiments, the block 44 occurs prior to the block 48. In some embodiments, the method 46 is separate from the method 30. In some embodiments, the method 30 and/or the method 46 may occur in real-time such that when the driver enters a parking garage, a parking spot is selected for the driver in real-time. In one or more embodiments, the method 30 and/or the method 46 occurs in real-time such that a driver does not have to drive through a parking area to locate a parking spot, which saves time and reduces emissions and stress.

In one or more embodiments, the display 28 depicts the selected parking spot in the block 44 and asks the driver on the graphical user interface of the display 28 if the user approves the selected parking spot. In some embodiments, the driver may input in the input device 20 whether the driver approves the selected parking spot. In other embodiments, the display 28 depicts the path to the selected parking spot at the block 48. If the driver drives along the path, then the driver has accepted the selected parking spot, in one or more embodiments.

In some embodiments, at the block 50, the parking spot identifier 24 may have to make another determination to find another selected parking spot. In other embodiments, the block 50 is omitted and the driver proceeds to park without using the parking spot identifier 24. In one or more embodiments, there are no alternative parking spots provided by the parking spot identifier 24, which may cause the driver to input new driver input 22 or selecting another parking area. In some embodiments, prior to the block 50, the driver inputs using the input device 20 further driver input 22 to determine a different parking spot for the driver. In one or more embodiments, the parking spot identifier 24 re-grades the parking spot and the skill of the driver prior to the block 50. In some embodiments, prior to block 50, the driver changes the driver's skill level or other parking settings (such as needing a parking spot with an EV charging station).

In one or more embodiments, the block 52 occurs simultaneously to or contemporaneously to the block 44. In some embodiments the block 52 occurs in place of the block 44. In one or more embodiments, the display 28 displays the route to the selected parking spot. The map data 16 and/or GPS 26 may be used to determine the route or navigational path to the parking spot. In one or more embodiments, the block 52 displays a 2-D map with a route to the selected parking spot. In other embodiments, the block 52 displays a 3-D map with a route to the selected parking spot.

In some embodiments, the block 54 requires the driver to park in the selected parking spot within a certain amount of time. In some embodiments, the block 54 requires the driver to park in the selected parking space on the first attempt to park in the parking spot in order to proceed to the block 56.

In some embodiments, the block 56 occurs prior to the block 42 of the method 30. In some embodiments, the block 56 includes applying or transmitting the determined incentive. In one or more embodiments, an incentive is provided to the driver for parking in the selected parking spot after the block 56. In some embodiments, the incentive and related parking information (e.g., which parking spot has what incentive) is stored in the parking database 14. In one or more embodiments, the incentive and related parking information is a portion of the map data 16. In some embodiments, the incentive and the related parking information is stored on a cloud and sent over the network 18 or a similar network upon entering the parking area. In some embodiments, the incentive is a financial incentive. For example, if the driver is looking for a parking spot with an EV charging station, the driver may receive a reduction of the cost to charge the vehicle if the driver uses the selected parking spot. In one or more embodiments, the incentive may be any one or more of: redeemable points, a reduction in EV charging costs, a reduction in fuel costs, money, priority parking rewards, reduction of parking area rates, and the like. In some embodiments, the owner of the parking area determines which parking spots receive an incentive. For example, an owner of a parking area may realize that few cars are parking on levels 4-5 of the parking area, but most of the cars are parked on levels 1-3. The owner of the parking area may add an incentive for drivers to park on levels 4-5, but not for levels 1-3. The incentive information may be part of the map data 16 sent to the vehicle 12 when the vehicle 12 enters the parking area at the blocks 32 and 34. In other embodiments, a parking area may have a group of parking spots that are very difficult to park in and require a driver with a high level of parking skill and/or a certain vehicle size. An incentive may be given to the driver for parking in a difficult parking spot, since many drivers could not park there. In other embodiments, a parking area may want to encourage a driver to use a particular EV charging station and provide an incentive to park at that EV charging station such as a reduction in cost to charge at the EV charging station. Therefore, in some embodiments, the owner of the parking area may incentivize parking in certain parking spots in order to efficiently fill their parking area. In some embodiments, an incentive is provided to any driver who parks in the selected parking spot, as an incentive to reduce emissions and congestion in a parking area. In some embodiments, another company besides the owner of the parking area provides the incentive.

In one or more embodiments, the parking spot identifier 24 notifies the driver that certain parking spots have incentives via the display 28 and asks the driver if the driver would like to park in a spot with an incentive. In some embodiments, the incentives are used in the parking spot identifier 24 selection of the at least one parking spot at the block 44, as part of the skill level of the driver as a desirability factor. In one or more embodiments, the parking spot identifier 24 includes incentive information in part of the grade of the parking spot. In some embodiments, if the driver has a high skill level for parking, then the driver is more likely to get a difficult parking spot selected, which in turn is more likely to have an incentive. In other embodiments, the driver may input in the driver input 22 their preferences for incentives. In some embodiments, the driver input 22 is stored and used for each time the driver parks in a parking area. For example, a driver may prefer a longer walk to the entrance for an incentive. Alternatively, a driver may prefer a shorter walk to the entrance, but due to their skill, prefer to park in difficult parking spots for an incentive.

In some embodiments, the input device 20 receives the incentive. In other embodiments, the charging station, parking meter, or fuel station receives the incentive and a reduction in price occurs. In some embodiments, the driver of the vehicle 12 receives the incentive on the driver's account or an application associated with parking. In some embodiments, the parking spot identifier 24 is further configured to transmit a request via a network (such as the network 18 or another network) that the driver receives the incentive. In one or more embodiments, the parking spot identifier 24 transmits a request via a network (such as the network 18 or another network) that the driver receives the incentive when the driver parks in the selected parking spot. In some embodiments, a component of vehicle 12 transmits a request that the driver has earned an incentive. In some embodiments, the request is sent to a device such as a parking meter, an EV charger, a third-party device, and the like.

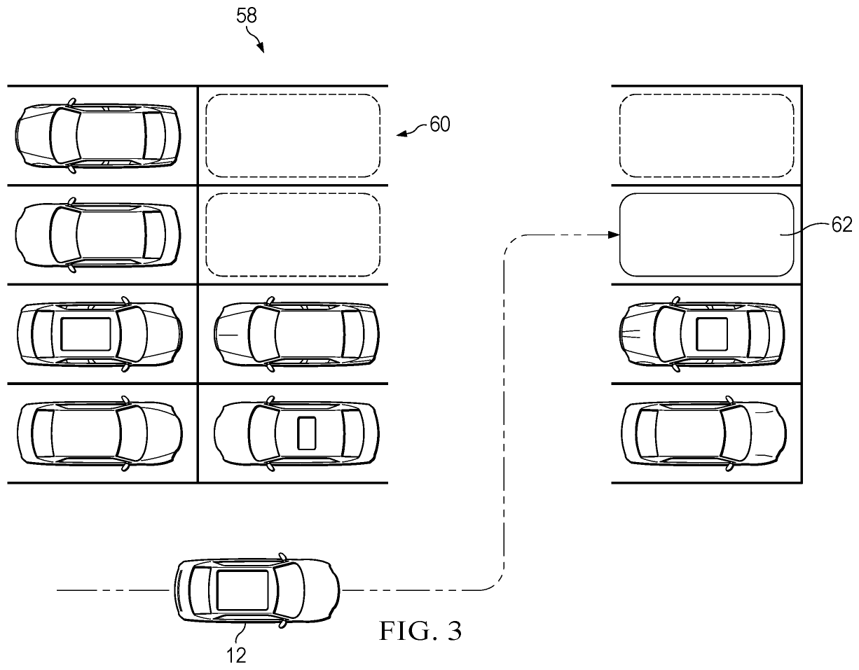

Referring to FIG. 3, with continuing reference to FIGS. 1, 2A, and 2B, depicts a diagrammatic illustration of a visually enhanced 2-D map of a parking lot in accordance with one or more embodiments. The parking lot is generally referred to by reference numeral 58. The parking lot has a plurality of open parking spots 60. However, the parking spot identifier 24 selects from the open parking spots 60, a parking spot 62 that aligns with the skill of the driver and the grade (e.g., the difficulty to park in the parking spot or if an incentive is provided) to display on the display 28. The display 28 may include a path or route to the parking spot 62 using the map data 16, other information from the parking database 14, and/or the GPS 26. In some embodiments, a visually enhanced 2-D map of the parking lot as shown in FIG. 3 is displayed on the display 28 to the user. In one or more embodiments, at least a portion of the visually enhanced 2-D map of the parking lot as shown in FIG. 3 is included and/or stored in the map data 16 in the parking database 14. In some embodiments, at least a portion of the visually enhanced 2-D map of the parking lot as shown in FIG. 3 is sent to the parking spot identifier 24 for processing.

In some embodiments, the parking lot 58 is displayed on display 28 at the block 44. In other embodiments, the parking lot 58 is shown on display 28 at the block 50 or the block 52.

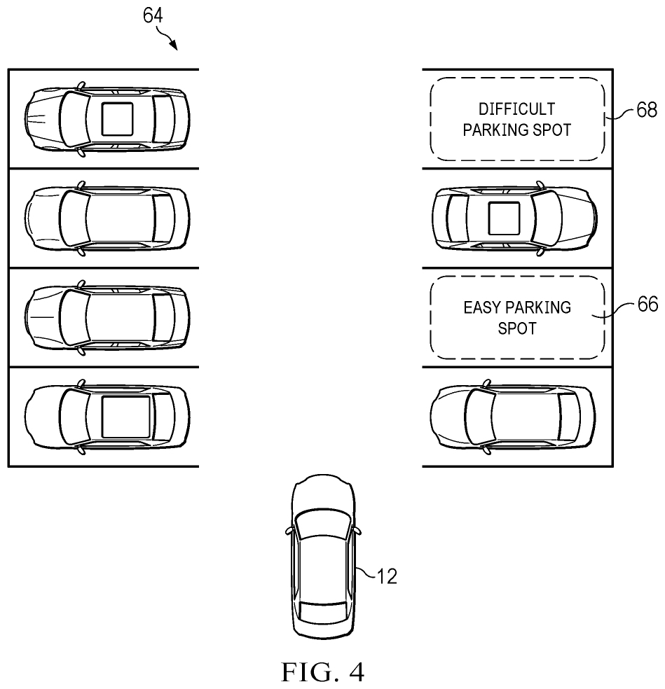

Referring to FIG. 4, with continuing reference to FIGS. 1, 2A, and 2B, depicts another diagrammatic illustration of a visually enhanced 2-D map of a parking lot in accordance with one or more embodiments. The parking lot is generally referred to by reference numeral 64. The parking lot has two open parking spots 66 and 68, respectively. The parking spot identifier 24 selects from the open parking spots 66 and 68, a parking spot that aligns with the skill of the driver and the grade (e.g., the difficulty to park in the parking spot or if an incentive is provided) to display on the display 28. The open parking spot 66 may be graded as an easy parking spot. The open parking spot 68 may be graded as a difficult parking spot. In some embodiments, the parking spot identifier 24 grades the open parking spots 66 and 68, respectively. In other embodiments, the grades of the open parking spots 66 and 68 may be included in the map data. In some embodiments, the grades of the open parking spots 66 and 68 are depicted on the display 28. In one or more embodiments, the grades of the open parking spots 66 and 68 are depicted by a certain color. For example, green for a parking spot that was graded easy, yellow/orange for a medium level parking spot, and red for a difficult level parking spot. In other embodiments, a graphical indicator and/or a text notation is used to mark the grade/required skill of the open parking spots 66 and 68. In some embodiments, the owner of the parking lot may grade the parking spots for difficulty and includes that in the parking database 14.

In some embodiments, the display 28 may include both open parking spots 66 and 68, respectively, using the map data 16, other information from the parking database 14, and/or the GPS 26. In some embodiments, the driver may select which parking spot of the open parking spots 66 and 68 to park in. In one or more embodiments, the driver may select on the display either open parking spot 66 or 68 to display more information about the respective parking spots. For example, the display 28 may update to include information about the parking spot such as parking level difficulty and/or whether an incentive is present for parking in the respective parking spot 66 or 68. In some embodiments, only open parking spot 68 would have an incentive to encourage drivers of adequate skill to park in this parking spot. In some embodiments, only drivers with a high-level skill receive the option of parking in either a difficult parking spot, like open parking spot 68, and an easy parking spot alternative, like open parking spot 66. In some embodiments, if the driver has a novice level of parking skill, the parking spot identifier would only select the open parking spot 66 as an option for the driver. In other embodiments, the driver may select which parking spot of the open parking spots 66 and 68 to park, and the display 28 will update to display a path or route to the selected parking spot.

In some embodiments, a visually enhanced 2-D map of the parking lot as shown in FIG. 4 is displayed on the display 28 to the user. In one or more embodiments, at least a portion of the visually enhanced 2-D map of the parking lot as shown in FIG. 4 is included and/or stored in the map data 16 in the parking database 14. In some embodiments, at least a portion of the visually enhanced 2-D map of the parking lot as shown in FIG. 4 is sent to the parking spot identifier 24 for processing. In some embodiments, the parking spot identifier 24 identifies whether the open parking spots 66 and 68 are easy or difficult to park in.

In some embodiments, the parking lot 64 is displayed on display 28 at the block 44. In other embodiments, the parking lot 64 is shown on display 28 at the block 50 or the block 52.

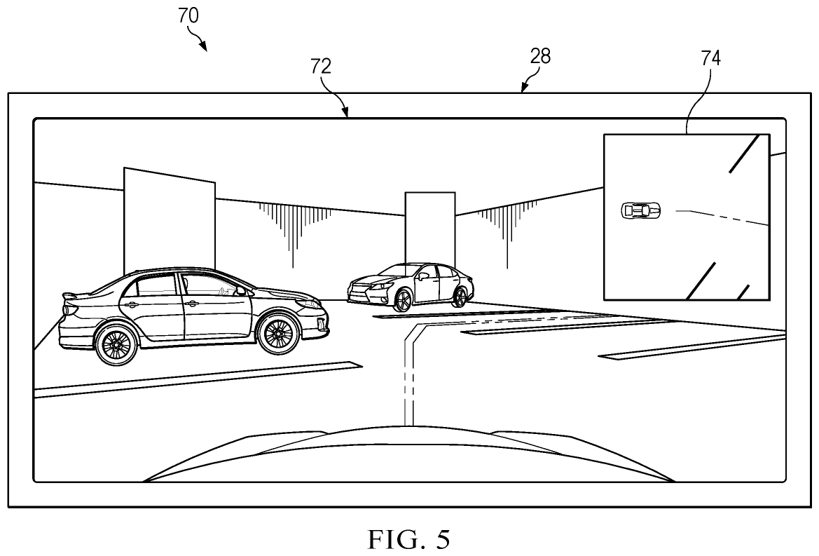

Referring to FIG. 5, with continuing reference to FIGS. 1, 2A, and 2B, depicts another diagrammatic illustration of a visually enhanced 3-D map of a parking lot in accordance with one or more embodiments. The parking lot display is generally referred to by reference numeral 70. The parking lot display 70 includes the display 28, a 3-D map 72, and an alternative view 74 of the 3-D map 72. In some embodiments, the 3-D map 72 includes the path and/or route to the selected parking spot. In some embodiments, the 3-D map 72 includes parking structure details, as well as other parked vehicles. In some embodiments, the 3-D map 72 includes at least a portion of the vehicle 12. In some embodiments, the alternative view 74 of the 3-D map is omitted. In other embodiments, the alternative view 74 is displayed simultaneously to the 3-D map 72. The alternative view 74, in some embodiments, is a top view. In some embodiments, the alternative view 74 is displayed side-by-side to the 3-D map 72. In other embodiments, the alternative view 74 is replaced with video from cameras from the vehicle 12. For example, if the driver decides to reverse in the parking spot, either both or one of the 3-D map 72 or the alternative view 74 may be replaced with camera data from the vehicle 12. In some embodiments, the 3-D map 72 is in black and white. In other embodiments, the 3-D map 72 is in color and includes graphical representations. The graphical representations may include an indicator or information related to incentives, an indicator for the path to the parking lot, directions to the parking spot, and the like regarding the open parking spots, in some embodiments.

In some embodiments, the map data 16 includes information relating to creating the 3-D map 72 and/or the alternative view 74. In some embodiments, the 3-D map 72 is stored in the parking database 14. In one or more embodiment, the structure of the parking area and open parking spots information is provided by the map data 16 and the path information is provided by the GPS 26. In some embodiments, the 3-D map 72 of the parking area is created by combining map data 16 with camera information from vehicle 12. In some embodiments, the 3-D map is an augmented reality view.

In other embodiments, a graphical representation of EV charging may also be displayed on the 3-D map 72. In some embodiments, the 3-D map 72 and/or the alternative view 74 is displayed at the block 44. In one or more embodiments, the 3-D map 72 and/or the alternative view 74 is displayed at the block 50 or the block 52.

In one or more embodiments, one or more of the embodiments described above and/or illustrated in FIGS. 1-5 include a computer program that includes a plurality of instructions, data, and/or any combination thereof; an application written in, for example, Arena, HyperText Markup Language (HTML), Cascading Style Sheets (CSS), JavaScript, Extensible Markup Language (XML), asynchronous JavaScript and XML (Ajax), and/or any combination thereof; a web-based application written in, for example, Java or Adobe Flex, which in one or more embodiments pulls real-time information from one or more servers, automatically refreshing with latest information at a predetermined time increment; or any combination thereof.

In one or more embodiments, a computer system typically includes at least hardware capable of executing machine readable instructions, as well as the software for executing acts (typically machine-readable instructions) that produce a desired result. In one or more embodiments, a computer system may include hybrids of hardware and software, as well as computer sub-systems.

In one or more embodiments, hardware generally includes at least processor-capable platforms, such as client-machines (also known as personal computers or servers), and hand-held processing devices (such as smart phones, tablet computers, or personal computing devices (PCDs), for example). In one or more embodiments, hardware may include any physical device that is capable of storing machine-readable instructions, such as memory or other data storage devices. In one or more embodiments, other forms of hardware include hardware sub-systems, including transfer devices such as modems, modem cards, ports, and port cards, for example.

In one or more embodiments, software includes any machine code stored in any memory medium, such as RAM or ROM, and machine code stored on other devices (such as floppy disks, flash memory, or a CD-ROM, for example). In one or more embodiments, software may include source or object code. In one or more embodiments, software encompasses any set of instructions capable of being executed on a node such as, for example, on a client machine or server.

In one or more examples, Unity Software™, gRPC®, .NET Core™, MagicOnion™, AWS®, and the like may be used to implement at least a portion of method 30 or method 46.

In one or more embodiments, combinations of software and hardware could also be used for providing enhanced functionality and performance for certain embodiments of the present disclosure. In an embodiment, software functions may be directly manufactured into a silicon chip. Accordingly, combinations of hardware and software are also included within the definition of a computer system and are thus envisioned by the present disclosure as possible equivalent structures and equivalent methods.

In one or more embodiments, computer readable mediums include, for example, passive data storage, such as a random-access memory (RAM) as well as semi-permanent data storage such as a compact disk read only memory (CD-ROM). One or more embodiments of the present disclosure may be embodied in the RAM of a computer to transform a standard computer into a new specific computing machine. In one or more embodiments, data structures are defined organizations of data that may enable an embodiment of the present disclosure. In an embodiment, a data structure may provide an organization of data, or an organization of executable code.

In one or more embodiments, any networks and/or one or more portions thereof may be designed to work on any specific architecture. In an embodiment, one or more portions of any networks may be executed on a single computer, local area networks, client-server networks, wide area networks, internets, hand-held and other portable and wireless devices and networks.

In one or more embodiments, a database (e.g., parking database 14) may be any standard or proprietary database software. In one or more embodiments, the database may have fields, records, data, and other database elements that may be associated through database specific software. In one or more embodiments, data may be mapped. In one or more embodiments, mapping is the process of associating one data entry with another data entry. In an embodiment, the data contained in the location of a character file can be mapped to a field in a second table. In one or more embodiments, the physical location of the database is not limiting, and the database may be distributed. In an embodiment, the database may exist remotely from the server, and run on a separate platform. In an embodiment, the database may be accessible across the Internet. In one or more embodiments, more than one database may be implemented.

In one or more embodiments, a plurality of instructions stored on a non-transitory computer readable medium may be executed by one or more processors to cause the one or more processors to carry out or implement in whole or in part one or more of the embodiments of one or more of the controller(s) (e.g., the parking spot identifier 24), element(s), apparatus, system(s) (e.g., the parking spot finder system 10, or any combination thereof), method(s) (e.g., the method 30, the method 46, the operation of any of the above-described systems, or any combination thereof), block(s), and/or sub-blocks(s), or any combination thereof, described above and/or illustrated in FIGS. 1 through 5. In one or more embodiments, such a processor may include one or more of the microprocessor(s) or any processor(s) that are part of the components of the above-described systems, such as, for example, the parking spot identifier, and such a computer readable medium may be distributed among one or more components of the system. In one or more embodiments, such a processor may execute the plurality of instructions in connection with a virtual computer system. In one or more embodiments, such a plurality of instructions may communicate directly with the one or more processors, and/or ay interact with one or more operating systems, middleware, firmware, other applications, and/or any combination thereof, to cause the one or more processors to execute the instructions.

A first method has been disclosed. The first method, in accordance with one or more embodiments, generally includes: receiving map data, by a parking spot identifier, via a network, upon entering a parking area; wherein the map data comprises sensor data, and wherein the parking spot identifier comprises a controller; determining, by the controller, available parking spots of the parking area based on the map data; grading, using the controller, one or more available parking spots of the parking area; grading, using the controller, a skill level of a driver; selecting, by the controller, a parking spot from the available parking spots, wherein the selection is based on the skill level of the driver and the grade of the one or more available parking spots; and wherein the selection includes determining if the selected parking spot includes a financial incentive if the driver parks in the respective selected parking spot; and outputting the selection on a display. In one or more embodiments, the first method includes displaying the selected parking spot on a display. In some embodiments, the first method includes displaying a route to the selected parking spot on the display. In one or more embodiments, if the selected parking spot has a financial incentive, the financial incentive is displayed on the display. In one or more embodiments, the skill level of the driver is a setting input by the driver. In one or more embodiments, the skill level of the driver includes preferences of the driver. In some embodiments, the preferences of the driver includes at least one of: a parking spot with a financial incentive; a parking spot with accessibility features; or a parking spot with an energy transfer system. In some embodiments, the skill level of the driver is determined to be one of: a novice, an intermediate, or an expert; the skill level of the novice, the intermediate, or the expert is based on a parking skill of the driver; the skill level of the novice is less than the skill level of the intermediate; and the skill level of the intermediate is less than the skill level of the expert. In one or more embodiments, a grade of each of the one or more available parking space is determined to be one of: easy, medium, or difficult; the grade of each of the one or more available parking spaces is based on difficulty to park in the corresponding parking space; the grade of easy is less than the grade of medium; and the grade of medium is less than the grade of difficult such that the grade of easy corresponds to the skill level of the novice, the grade of medium corresponds to the skill level of the intermediate, and the grade of difficult corresponds to the skill level of the expert. In one or more embodiments, in order to be selected as the selected parking spot, the grade of the one or more available parking spots of the parking area must be equal to or less than the skill level of the driver.

A first system has been disclosed. The first system, in accordance with one or more embodiments, generally includes: a parking database, a parking database, wherein the parking database includes map data, and wherein the parking database is in communication with a parking spot identifier; a parking spot identifier, wherein the parking spot identifier includes a controller, wherein the controller is configured to: receive, via a network, the map data upon entering a parking area; determine available parking spots of the parking area based on the map data; grade one or more available parking spots of the parking area based on at least difficulty to park in the corresponding available parking spot; grade a skill level of a driver; select one parking spot from the available parking spots, wherein the selection is based on the skill level of the driver and the grade of the one or more available parking spots; and determine if the one selected parking spot comprises a financial incentive if the driver parks in the selected parking spot; and a display, wherein the display is configured to output the one selected parking spot. In one or more embodiments, the first system includes an input device in communication with the parking spot identifier, wherein the input device includes driver input relating to the skill level of the driver. In one or more embodiments, the first system includes a global positioning system (GPS), wherein the GPS determines a path from an entrance to the one selected parking spot, and wherein the display updates to graphically depict the path. In some embodiments, the display shows a 3-D map of the parking area. In some embodiments, the display includes a 2-D map of the area and graphical indicators on the 2-D map, wherein the graphical indicators includes at least one of: available parking spots; the one or more selected parking spots; parking spots with an energy transfer station; or parking spots with a financial incentive. In some embodiments, the display includes graphical indicators based on the grade of one or more available parking spots. In one or more embodiments, the financial incentive includes at least one of: a reduction in price for an energy transfer station; a reduction in parking rates; or redeemable points.

A second system has been disclosed. The second system in accordance with one or more embodiments generally includes a parking database, wherein the parking database includes map data, wherein the map data includes sensor data from a parking area, wherein the parking database is in communication with a parking spot identifier, and wherein the parking spot identifier includes a controller; the controller configured to: receive, via a network, the map data upon entering the parking area; determine available parking spots of the parking area based on the received map data; grade the one or more available parking spots of the parking area based on at least difficulty to park in the corresponding available parking spot; grade a skill level of a driver; select one parking spot from the available parking spots to display to the driver of the vehicle. wherein the selection is based on the skill level of the driver and the grade of the one or more available parking spots; determine that the selected parking spot includes an incentive if the driver parks in the selected parking spot; and determine that the driver has parked in the selected parking spot; and a display, wherein the display is configured to output at least the selected parking spot. In one or more embodiments, the parking spot identifier is further configured to transmit a request to a device that the driver receives the incentive. In one or more embodiments, the grading of the skill level of the driver is based on at least one of: vehicle history of the driver; information provided by the driver; or settings input by the driver.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different blocks, processes, and procedures are described as appearing as distinct acts, one or more of the blocks, one or more of the processes, and/or one or more of the procedures may also be performed in different orders, simultaneously, and/or sequentially. In several example embodiments, the blocks, processes and/or procedures may be merged into one or more blocks, processes, and/or procedures.

In several example embodiments, one or more of the operational blocks in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

The phrase “at least one of A and B” should be understood to mean “A; B; or both A and B.” The phrase “one or more of the following: A, B, and C” should be understood to mean “A; B; C; A and B; B and C; A and C; or all three of A, B, and C.” The phrase “one or more of A, B, and C” should be understood to mean “A; B; C; A and B; B and C; A and C; or all three of A, B, and C.”

Although several example embodiments have been described in detail above, the embodiments described are examples only and are not limiting, and those skilled in the art will readily appreciate that many other modifications, changes, and/or substitutions are possible in the example embodiments without materially departing from the novel teachings and advantages of the present disclosure. Accordingly, all such modifications, changes, and/or substitutions are intended to be included within the scope of this disclosure as defined in the following claims. In the claims, any means-plus-function clauses are intended to cover the structures described herein as performing the recited function and not only structural equivalents, but also equivalent structures. Moreover, it is the express intention of the applicant not to invoke 35 U.S.C. § 112(f) for any limitations of any of the claims herein, except for those in which the claim expressly uses the word “means” together with an associated function.

What is claimed is:

1. A computer-implemented method comprising:
receiving map data, by a parking spot identifier, via a network, upon entering a parking area,
wherein the map data comprises sensor data, and
wherein the parking spot identifier comprises a controller;
determining, by the controller, available parking spots of the parking area based on the received map data;
grading, using the controller, one or more available parking spots of the parking area;
grading, using the controller, a skill level of a driver;
selecting, by the controller, a parking spot from the available parking spots,
wherein the selection is based on the skill level of the driver and the grade of the one or more available parking spots; and
wherein the selection comprises determining if the selected parking spot comprises a financial incentive if the driver parks in the respective selected parking spot; and
outputting the selection on a display.

2. The computer-implemented method of claim 1, wherein outputting the selection comprises:
displaying a visual representation of the selected parking spot on a display.

3. The computer-implemented method of claim 2, wherein outputting the selection comprises:
displaying a route to the selected parking spot on the display.

4. The computer-implemented method of claim 2, wherein if the selected parking spot has a financial incentive, displaying the financial incentive on the display.

5. The computer-implemented method of claim 1, wherein the skill level of the driver is a setting input by the driver.

6. The computer-implemented method of claim 1, wherein the skill level of the driver comprises preferences of the driver.

7. The computer-implemented method of claim 6, wherein the preferences of the driver comprise at least one of:
a parking spot with a financial incentive;
a parking spot with accessibility features; or
a parking spot with an energy transfer system.

8. The computer-implemented method of claim 1,
wherein the skill level of the driver is determined to be one of:
a novice, an intermediate, or an expert;
wherein the skill level of the novice, the intermediate, or the expert is based on a parking skill of the driver;
wherein the skill level of the novice is less than the skill level of the intermediate; and
wherein the skill level of the intermediate is less than the skill level of the expert.

9. The computer-implemented method of claim 8,
wherein a grade of each of the one or more available parking space is determined to be one of: easy, medium, or difficult;
wherein the grade of each of the one or more available parking spaces is based on difficulty to park in the corresponding parking space;
wherein the grade of easy is less than the grade of medium; and
wherein the grade of medium is less than the grade of difficult such that the grade of easy corresponds to the skill level of the novice, the grade of medium corresponds to the skill level of the intermediate, and the grade of difficult corresponds to the skill level of the expert.

10. The computer-implemented method of claim 8, wherein in order to be selected as the selected parking spot, the grade of the one or more available parking spots of the parking area must be equal to or less than the skill level of the driver.

11. A parking guidance system for a vehicle comprising:
a parking database,
wherein the parking database comprises map data, and
wherein the parking database is in communication with a parking spot identifier;
a parking spot identifier, wherein the parking spot identifier comprises a controller,
wherein the controller is configured to:
receive, via a network, the map data upon entering a parking area;
determine available parking spots of the parking area based on the map data;
grade one or more available parking spots of the parking area based on at least difficulty to park in the corresponding available parking spot;
grade a skill level of a driver;
select one parking spot from the available parking spots,
wherein the selection is based on the skill level of the driver and the grade of the one or more available parking spots; and
determine if the one selected parking spot comprises a financial incentive if the driver parks in the selected parking spot; and
a display, wherein the display is configured to output the one selected parking spot.

12. The system of claim 11, wherein the parking system further comprises:
an input device in communication with the parking spot identifier,
wherein the input device comprises driver input relating to the skill level of the driver.

13. The system of claim 11, wherein the parking system further comprises:
a global positioning system (GPS),
wherein the GPS determines a path from an entrance to the one selected parking spot, and
wherein the display updates to graphically depict the path.

14. The system of claim 11, wherein the display shows a 3-D map of the parking area.

15. The system of claim 11, wherein the display comprises a 2-D map of the area and graphical indicators on the 2-D map, wherein the graphical indicators comprise at least one of:
available parking spots;
the one or more selected parking spots;
parking spots with an energy transfer station; or
parking spots with a financial incentive.

16. The system of claim 11, wherein the display comprises graphical indicators based on the grade of one or more available parking spots.

17. The system of claim 11, wherein the financial incentive comprises at least one of:
a reduction in price for an energy transfer station;
a reduction in parking rates; or
redeemable points.

18. An incentive-based parking system for a vehicle comprising:
a parking database,
wherein the parking database comprises map data,
wherein the map data comprises sensor data from a parking area,
wherein the parking database is in communication with a parking spot identifier, and
wherein the parking spot identifier comprises a controller;
the controller configured to:
receive, via a network, the map data upon entering the parking area;
determine available parking spots of the parking area based on the received map data;
grade the one or more available parking spots of the parking area based on at least difficulty to park in the corresponding available parking spot;
grade a skill level of a driver;
select one parking spot from the available parking spots to display to the driver of the vehicle,
wherein the selection is based on the skill level of the driver and the grade of the one or more available parking spots;
determine that the selected parking spot comprises an incentive if the driver parks in the selected parking spot; and
determine that the driver has parked in the selected parking spot; and
a display, wherein the display is configured to output at least the selected parking spot.

19. The system of claim 18, wherein the parking spot identifier is further configured to transmit a request to a device that the driver receives the incentive.

20. The system of claim 19, wherein grading of the skill level of the driver is based on at least one of:
vehicle history of the driver;
information provided by the driver; or
settings input by the driver.
